(19) United States
(12) Patent Application Publication
(10) Pub. No.: US 2011/0303294 A1
(43) Pub. Date: Dec. 15, 2011

(54) BALL-SEAT APPARATUS AND METHOD

(75) Inventors: Mohan L. Soni, Katy, TX (US); Gaurav Agrawal, Aurora, CO (US)

(73) Assignee: BAKER HUGHES INCORPORATED, Houston, TX (US)

(21) Appl. No.: 12/813,842

(22) Filed: Jun. 11, 2010

(51) Int. Cl. F16L 55/10

(52) U.S. Cl. 137/1; 138/40

(57) ABSTRACT

An apparatus for restricting fluid flow includes: a ball receiving element disposed in a fluid conduit and configured to receive a ball that has been advanced through the fluid conduit and at least partially restrict fluid flow; and at least one feature disposed on at least one of the fluid conduit and the ball seat configured to reflect pressure waves generated by an impact between the ball and the ball seat.

### BACKGROUND

In the drilling and completion industry and for example in hydrocarbon exploration and recovery operations, a variety of components and tools are lowered into a borehole for various operations such as production operations, for example. Some downhole tools utilize ball-seat assemblies to act as a valve or actuator. Ball-seat assemblies are used with, for example, hydraulic disconnects, circulating subs and inflatable packers.

Actuation of a ball-seat assembly generally includes releasing a ball or other plug into a fluid conduit and allowing the ball to drop onto the ball seat and restrict fluid flow therein. The impact between the ball and the ball seat can produce pressure waves, which can cause wear and/or damage to components of the assembly.

### SUMMARY

An apparatus for restricting fluid flow includes: a ball receiving element disposed in a fluid conduit and configured to receive a ball that has been advanced through the fluid conduit and at least partially restrict fluid flow; and at least one feature disposed on at least one of the fluid conduit and the ball seat configured to reflect pressure waves generated by an impact between the ball and the ball seat.

A method of restricting fluid flow includes: releasing a ball into a fluid conduit and receiving the ball in a ball receiving element disposed at the fluid conduit and at least partially restricting fluid flow; and partially reflecting one or more pressure waves resulting from an impact between the ball and the ball seat by at least one feature disposed on at least one of the longitudinal conduit and the ball seat.

### BRIEF DESCRIPTION OF THE DRAWINGS

The following descriptions should not be considered limiting in any way. With reference to the accompanying drawings, like elements are numbered alike:

FIG. 1 is a cross-sectional view of an embodiment of a ball-seat assembly;

FIG. 2 is a partial cross-sectional view of the ball-seat assembly of FIG. 1 including reflecting features; and

FIG. 3 is a flow diagram depicting a method of restricting fluid flow in a conduit.

### DETAILED DESCRIPTION

The apparatuses, systems and methods described herein provide for the mitigation of pressure waves caused by actuation of a ball-seat assembly. A downhole assembly includes a conduit having a longitudinal component to guide a ball released into the conduit to a receiving element such as a ball seat. The conduit and/or the ball seat includes one or more features configured to reflect pressure waves caused by, for example, the impact between the ball and the seat. The reflected pressure waves destructively interfere with incident pressure waves to reduce the amplitude of the incident pressure waves and reduce damage and/or wear on downhole components such as the ball and the ball seat.

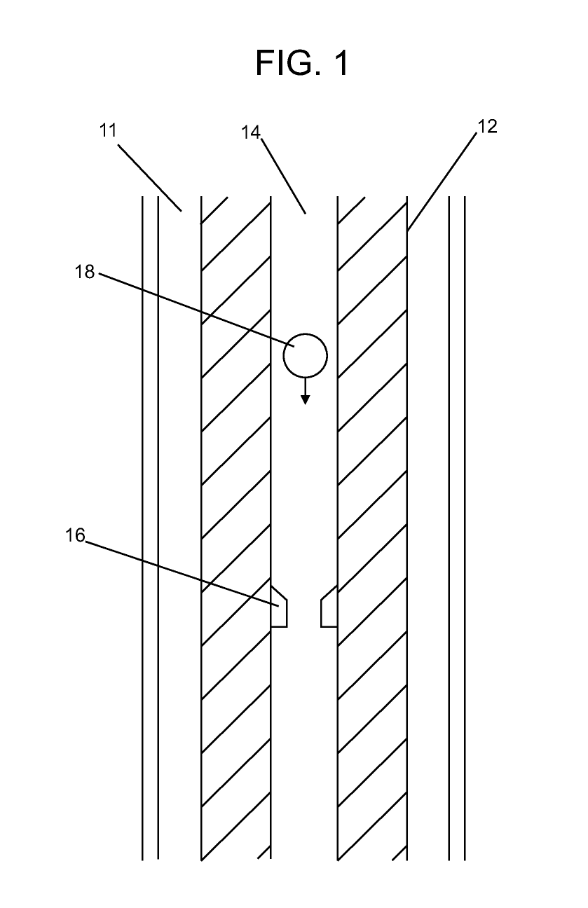

Referring to FIG. 1, a downhole tool 10, such as a ball seat sub, configured to be disposed in a borehole 11, includes a housing 12 having a longitudinal bore or fluid conduit 14. A ball-seat assembly includes a ball seat 16 included in the conduit 14 to retain a ball 18 that is released into the conduit 14. In one embodiment, the ball 18 is a spherical metal or plastic plug, although “ball” may refer to any type of moveable or droppable plugging element, such as a drop plug, and may take any desired shape or size. Actuation of the ball seat assembly includes releasing the ball into the fluid conduit 14, for example by dropping the ball 18 into and/or pumping the ball 18 through the fluid conduit 14 from a surface or downhole location. The ball 18 falls and/or is advanced by downhole fluid toward the ball seat 16 and is seated on the ball seat 16 to restrict fluid flow through the conduit 14.

The ball seat 16 may be an annular component connected to the conduit 14, or any other device or configuration providing a restriction in the diameter or cross-sectional area of the conduit 14 sufficient to prevent the ball 18 from passing therethrough. In one embodiment, the ball seat 16 is directly disposed on and/or attached to the inner surface of the conduit 14 or is formed from a reduced diameter portion of the conduit 14. In one embodiment, the ball seat is disposed on or is part of a movable component such as a sliding sleeve for use, for example, as an actuator or valve.

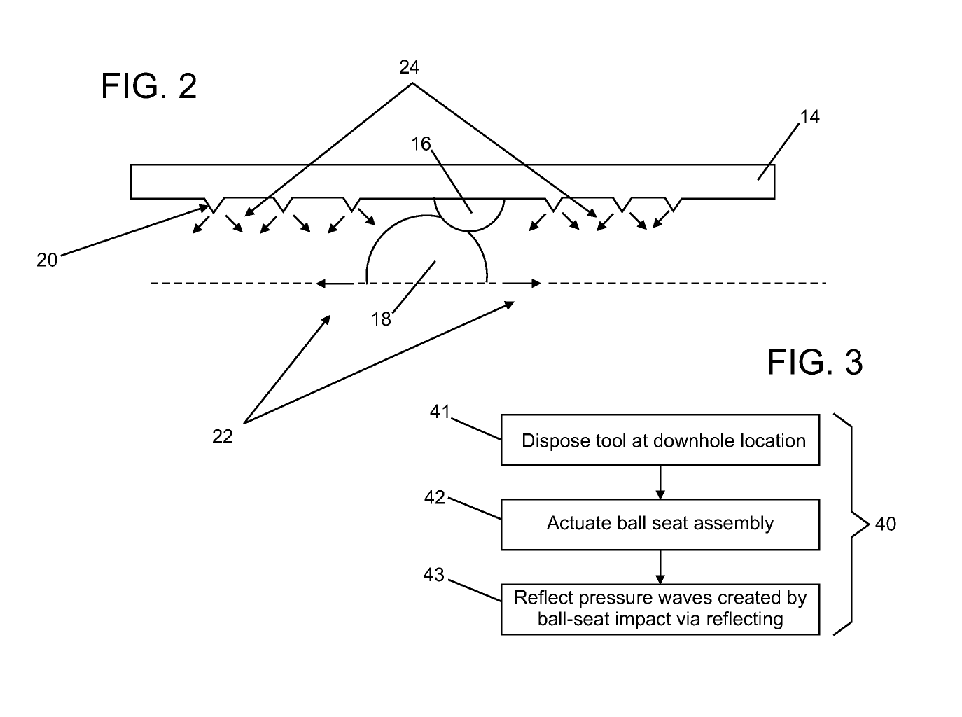

Referring to FIG. 2, the conduit 14 and/or the ball seat 16 includes one or more reflecting features 20 disposed thereon. Each reflecting feature 20 includes one or more reflecting surfaces that are configured to reflect incident pressure waves 22 generated by ball-seat impact. The reflected pressure waves 24 partially interfere with or cancel out the original pressure waves 22 created at the time of impact. The loading severity and therefore the service life of the ball-seat assembly is a function of factors such as the amplitude of the loading due to pressure waves on ball-seat assembly components as well as the direction of such loading. The features 20 act to reduce the amplitude of the pressure waves 22 and the duration of impact by attenuating the initial loading via reflections of pressure waves 22 which are opposite in magnitude to the pressure waves 22. The features 20 may include a plurality of reflecting features distributed longitudinally along a length of the conduit 14. Each of the plurality of features partially reflects the pressure wave(s) 22 as it advances along the conduit, resulting in multiple reflected waves that are spread over time. The features 20 and corresponding reflective surfaces may be positioned at any desired location at or proximate to the ball seat 16, and/or along the length of the conduit 14. For example, by positioning the reflecting features 20 in close proximity to the ball seat 16, the time span between loading and unloading can be reduced as desired.

The features 20 may be any configuration or mechanism configured to provide reflecting surfaces within the conduit 14 and within fluid flowing through the conduit 14. The features 20 may protrude radially inwardly to reflect the pressure waves 22. In one embodiment, the features 20 are built into the inner surface of the conduit 14 or sleeve. For example, the features 20 may be an integral component of the conduit construction.

In one embodiment, the features 20 include periodic or random contours in the inner surface of the conduit 14. For example, the inner surface may be roughened or otherwise have discontinuities at selected portions of the conduit 14. Other examples of features include saw tooths, baffles, wire screens, and/or macro roughness that is disposed on or part of the interior surface of the conduit 14. In one embodiment, the features 20 include one or more moveable and/or articulated reflecting surfaces such as baffles that are mechanically (via a linkage mechanism) or electrically (making use of a relative movement between a magnet and an electrical conductor) actuated upon the ball-seat impact. In one example, the pressure waves 22 generated by the impact can be utilize to trigger the features 20.

The downhole tool 10 is not limited to that described herein. The downhole tool 10 may include any tool, carrier or component that includes a ball seat assembly. The carriers described herein, such as a production string and a screen, are not limited to the specific embodiments disclosed herein. A “carrier” as described herein means any device, device component, combination of devices, media and/or member that may be used to convey, house, support or otherwise facilitate the use of another device, device component, combination of devices, media and/or member. Exemplary non-limiting carriers include borehole strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings. In addition, the downhole tool 10 is not limited to components configured for downhole use.

FIG. 3 illustrates a method 40 of restricting fluid flow in a component. The method includes, for example, actuating a valve or packer in a downhole assembly. The method 40 includes one or more stages 41-43. Although the method is described in conjunction with the tool 10, the method can be utilized in conjunction with any device or system (configured for downhole or surface use) that utilizes a ball-seat assembly.

In the first stage 41, in one embodiment, the tool 10 is disposed at a downhole location, via for example a borehole string or wireline. In the second stage 42, the ball-seat assembly is actuated by releasing the ball 18 into the conduit 14, for example by dropping the ball 18 into the conduit 14 and/or pumping the ball 18 through the conduit 14. The ball 18 advances through the conduit 14 and impacts the ball seat 16. In the third stage 43, reflecting features 20 at the ball seat 16 and/or the conduit 14 partially reflect pressure waves 22 resulting from the impact. In the example shown in FIG. 2, random reflections 24 from the reflecting surfaces on the reflecting features 20 produce multiple reflections spread over time and destructively interfere with the incident pressure waves 22, reducing the sharpness of the pressure-time response.

In one embodiment, the reflective features 20 are actuateable features such as baffles. The features 20 may be actuated as part of the third stage 43 by a mechanism triggered by the ball seat 16. For example, the triggering mechanism may include a magnetic material in the ball 18 or the ball seat 16 that moves upon actuation of the assembly and/or impact, causing an electrical signal in a conductor that can be used to trigger a baffle or other articulated mechanism to move reflective surfaces into the conduit 14.

The systems and methods described herein provide various advantages over existing processing methods and devices. The net reduction in pressure surge on the ball-seat assembly can enable the use of a wider range of construction materials and reduce the complexity of ball-seat design, for example by reducing the need for relatively complex ball seat designs to reduce impact. In addition, the apparatuses can allow for the ball seat to have a larger inner diameter due to the reduced contact stress.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

1. An apparatus for restricting fluid flow, comprising:
a ball receiving element disposed in a fluid conduit and configured to receive a ball that has been advanced through the fluid conduit and at least partially restrict fluid flow; and
at least one feature disposed on at least one of the fluid conduit and the ball seat configured to reflect pressure waves generated by an impact between the ball and the ball seat.

2. The apparatus of claim 1, wherein the at least one feature is a reflecting feature disposed at an inner surface of the fluid conduit.

3. The apparatus of claim 1, wherein the at least one feature includes one or more discontinuities of an inner surface of the conduit.

4. The apparatus of claim 3, wherein the discontinuities are a roughened portion of the inner surface.

5. The apparatus of claim 1, wherein the at least one feature includes one or more moveable members configured to be actuated in response to the release or the impact.

6. The apparatus of claim 5, wherein the one or more moveable members include one or more baffles.

7. The apparatus of claim 1, wherein the at least one reflecting feature includes at least one saw tooth shape on an inner surface of the fluid conduit.

8. The apparatus of claim 1, wherein the at least one feature includes a plurality of features distributed along a length of the fluid conduit.

9. The apparatus of claim 1, further comprising a carrier including the fluid conduit and configured to be disposed in a borehole.

10. The apparatus of claim 9, wherein the ball is configured to be at least one of dropped into and pumped through the fluid conduit.

11. A method of restricting fluid flow, comprising:
releasing a ball into a fluid conduit and receiving the ball in a ball receiving element disposed at the fluid conduit and at least partially restricting fluid flow; and
partially reflecting one or more pressure waves resulting from an impact between the ball and the ball receiving element by at least one feature disposed on at least one of the longitudinal conduit and the ball receiving element.

12. The method of claim 11, wherein the at least one feature includes a moveable feature configured to be actuated to move at least one reflective surface into the fluid conduit.

13. The method of claim 12, wherein the moveable feature is configured to be actuated by at least one of releasing the ball and the impact.

14. The method of claim 11, wherein the at least one feature is a reflecting feature disposed at an inner surface of the fluid conduit.

15. The method of claim 11, wherein the at least one feature includes one or more discontinuities of an inner surface of the conduit.

16. The method of claim 15, wherein the discontinuities are a roughened portion of the inner surface.

17. The method of claim 11, wherein the at least one reflecting feature includes at least one saw tooth shape on an inner surface of the fluid conduit.

18. The method of claim 11, wherein the at least one feature includes a plurality of features distributed along a length of the fluid conduit.

19. The method of claim 11, wherein reflecting includes generating multiple reflected pressure waves spread over time and destructively interfering with the at least one pressure wave.

20. The method of claim 11, wherein partially reflecting includes generating at least one reflected wave that destructively interferes with the one or more pressure waves.
